(19) United States
(12) Patent Application Publication
(10) Pub. No.: US 2015/0353333 A1
(43) Pub. Date: Dec. 10, 2015

(54) Encased Wine Opener With Bottle Opener

(71) Applicant: Rush D. Dixon, III, Mount Pleasant, SC (US)

(72) Inventor: Rush D. Dixon, III, Mount Pleasant, SC (US)

(21) Appl. No.: 14/731,435

(22) Filed: Jun. 5, 2015

Related U.S. Application Data
(60) Provisional application No. 62/008,717, filed on Jun. 6, 2014.

(51) Int. Cl. B67B 7/44; B67B 7/16; B67B 7/04

(52) U.S. Cl. CPC B67B 7/44; B67B 7/0417; B67B 7/16

(57) ABSTRACT

An improved wine opener/bottle opener that may be encased within an attractive housing, wherein the user may manipulate the position of the opener and bottle opener to accommodate different sized users as well as different sized bottles.

### BACKGROUND OF THE INVENTION

1) Field of the Invention

The present invention relates to an improved combination wine bottle opener and bottle cap opener that allows for better leverage and convenient storage of the opener implement while providing an aesthetically pleasing appearance.

2) Description of Related Art

A corkscrew is a kitchen tool for drawing corks from wine bottles. Generally, a corkscrew consists of a pointed metallic helix (often called the “worm”) attached to a handle. See FIG. 1. The user grips the handle and screws the metal point into the cork, until the helix is firmly embedded, then a vertical pull on the corkscrew extracts the cork from the bottle. Corkscrews are necessary because corks themselves, being small and smooth, are difficult to grip and remove, particularly when inserted fully into an inflexible glass bottle. The handle of the corkscrew, often a horizontal bar of wood attached to the screw, allows for a commanding grip to ease removal of the cork. Corkscrew handles may incorporate levers that further increase the amount of force that can be applied outwards upon the cork.

Various forms of bottle openers, such as cork screws, exist. For instance, the common wine opener, also known as a sommelier knife, waiter's friend, or wine key, consists of a flat housing, often plastic covered, similar to a Swiss army knife with a corkscrew and lever, which may double as a crown cork opener. See FIG. 2. The common wine opener has either a knife or auto-foiler to remove the foil top of wine bottles and then the cork. The opener is designed to be screwed in to within one full rotation before the end of the screw. Deeper and the screw will pierce the bottom of the cork and result in extra flotsam on the surface of the wine. Once secured, the screw is used to lever the cork from the bottle opening.

Another common opener, the twin prong cork puller, also known as the Butler's Friend or Ah-So, is shaped like a large key with a squared oval handle about 5 cm by 8 cm, and two thin metal strips, approximately 10 cm long, 5 mm wide, and 0.5 mm thick, descending in tandem from the center of the handle. See FIG. 3. The two strips are spread open and then wiggled into the space between the cork and the bottle on either side. Once fully in place, a turn and pull of the handle causes friction to turn the cork and pull it out of the bottle.

First invented in 1939, a wing corkscrew, see FIG. 4, sometimes called a butterfly corkscrew or angel corkscrew, has two levers, one on either side of the worm. As the worm is twisted into the cork, the levers are raised. Pushing down the levers draws the cork from the bottle in one smooth motion. The most common design has a rack and pinion connecting the levers to the body. The head of the central shaft is frequently modified to form a bottle opener, increasing the utility of the device. Corkscrews of this design are particularly popular in household use.

The original design of a corkscrew is believed to have possibly derived from the gun worm which was a device used by musketmen to remove unspent charges from a musket's barrel in a similar fashion, from at least the early 1630s. The corkscrew is possibly an English invention, due to the tradition of beer and cider, and Treatise on Cider by John Worlidge in 1676 describes “binning of tightly corked cider bottles on their sides”, although the earliest reference to a corkscrew is, “steel worm used for the drawing of Corks out of Bottles” from 1681. Modern wine openers may contain motorized or geared openers to aid in opening.

Wine openers such as cork screws, generally, are inelegant and ungainly in appearance and are often hidden away in drawers to be lost, until needed for the next bottle of wine. What is needed in the art is a wine bottle opener with a simple, yet pleasing, design that not only serves to open wine bottles, but may remove the caps of other bottles as well. Additionally, a self-contained wine opener that allows the user to manipulate the screw position within the opener for improved leverage is also needed.

Accordingly, it is an object of the present invention to present an improved wine opener/bottle opener that may be encased within an attractive housing, wherein the user may manipulate the position of the wine opener and bottle opener to accommodate different sized users as well as different sized bottles.

### SUMMARY OF THE INVENTION

In one embodiment, a combination corkscrew/bottle opener is provided. The opener includes a rounded concave housing defining at least one open face and having at least one engaging surface. An opener base is orbitally attached to the at least one engaging surface. An opener is attached to the opener base, wherein the opener is capable of rotating at least 180 degrees with respect to the engaging surface. At least one bottle opener is formed by one surface of the opener base and a portion of the concave housing.

In a further embodiment, the rounded concave housing is shaped to resemble one-half of a baseball cover. In a further embodiment, the rounded concave housing has opposing sides that form the rounded concave housing. In a still further embodiment, there is a first open face and a second open face. The shape of the first open face and the second open face together define substantially the same shape as the rounded concave housing. Still further, the first open face and the second open face define a shape resembling one-half of a baseball cover.

In another embodiment, the opener has at least an open and a closed position, wherein in the closed position, the opener is located within and surrounded by the rounded concave housing. In a further embodiment, the opener is locked into place along various points of its rotation. In a still further embodiment, the at least one bottle opener is formed by an edge of the rounded concave housing and a leverage point located on the opener base. Still even further, the leverage point comprises a raised protrusion on the opener base. In a yet further embodiment, the opener base is in the form of a cam and the orientation of the cam remains substantially stationary with respect to a rim of a wine bottle being opened.

In an alternative embodiment, a shaped corkscrew is provided. The corkscrew has a continuous surface forming a rounded concave housing defining at least one open face. The continuous surface also has at least one engaging surface and an opener base rotationally attached to the at least one engaging surface. An opener is attached to the opener base and the opener and opener base are capable of radial rotation with respect to the engaging surface. A leverage point is formed on one surface of the opener base.

In a further embodiment, the continuous surface is shaped to resemble one-half of a baseball cover. In a still further embodiment, the continuous surface has opposing sides that form the rounded concave housing. Yet further, the continuous surface defines a first open face and a second open face. The shape of the first open face and the second open face together define substantially the same shape as the rounded concave housing. Still further, the first open face and the second open face define a shape resembling one-half of a baseball cover.

In a still further embodiment, the opener has at least an open and a closed position; n the closed position, the opener is located within and surrounded by the continuous surface. In another embodiment, the opener locks into place along various points of its rotation. In a still further embodiment, at least one bottle opener is formed wherein the leverage point is a raised protrusion located on the opener base that cooperates with a portion of the continuous surface. In another embodiment, the opener base is in the form of a cam. The orientation of the cam remains substantially stationary with respect to a rim of a wine bottle being opened.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a prior art basic cork screw.

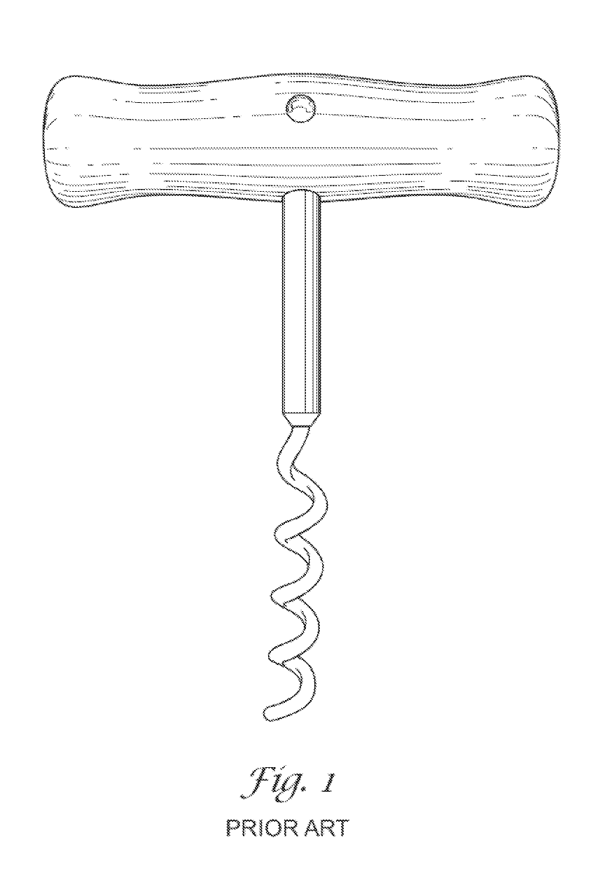

FIG. 2 shows a prior art sommelier's knife.

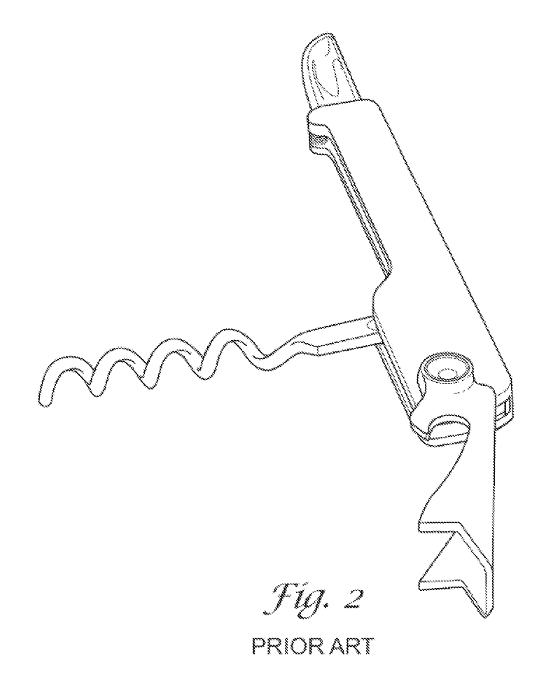

FIG. 3 shows a prior art twin prong cork puller.

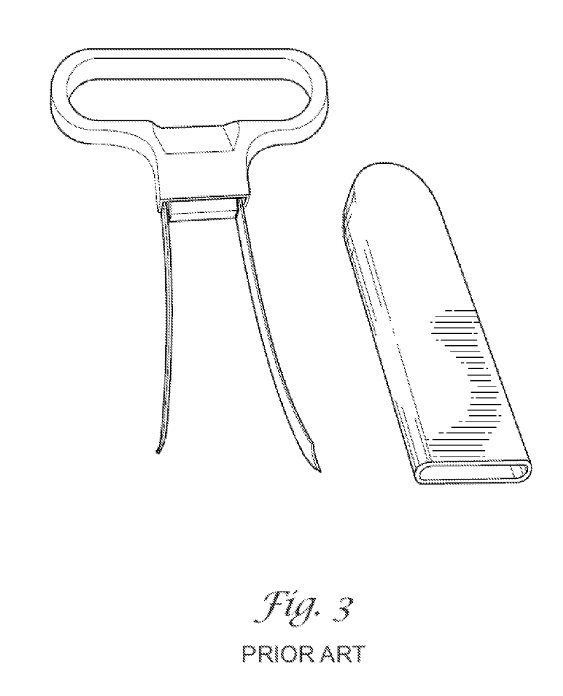

FIG. 4 shows a prior art winged corkscrew.

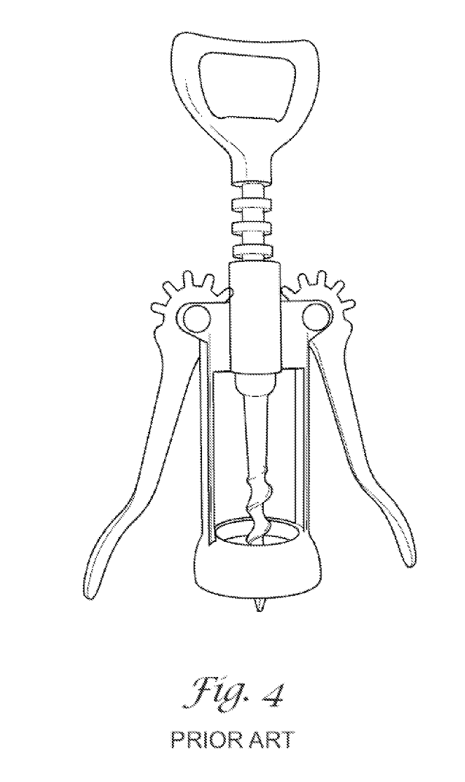

FIG. 5 shows an opener of the present disclosure in a closed position.

FIG. 6 illustrates one possible embodiment of the present disclosure as it is used to remove a cork from a bottle.

FIG. 7 shows an opener of the present invention disassembled.

FIG. 8 shows an opener of the present disclosure engaged with a beer bottle.

FIG. 9 shows an opener of the present disclosure engaged with a wine bottle.

FIG. 10 shoes an opener of the present disclosure rotated with respect to its base.

FIG. 11 shows an alternative embodiment of the opener disclosed herein.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

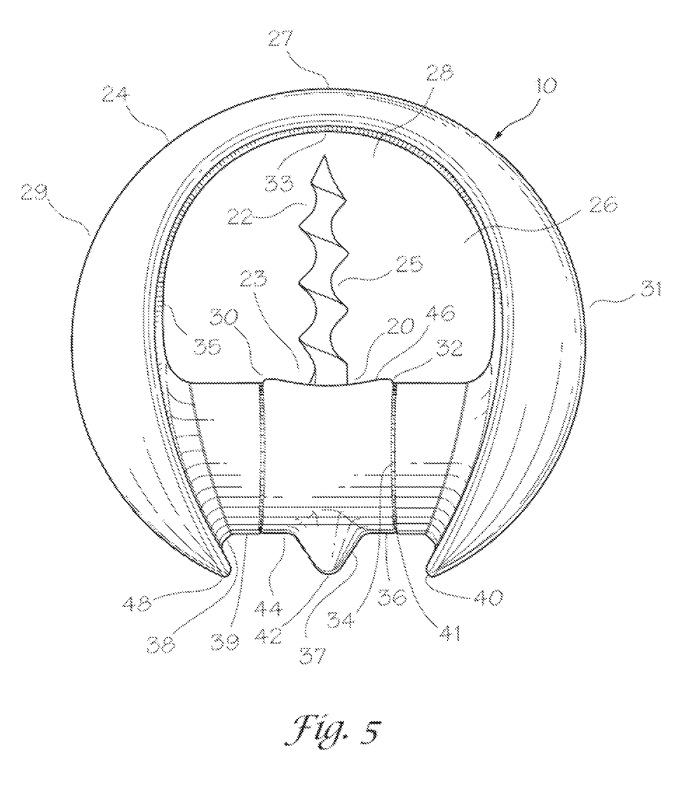

FIG. 5 shows an opener 10 of the present disclosure in a closed position 20 wherein opener 22 is positioned inside rounded concave housing 24. Although opener 22 is illustrated by a cork screw 25 having the typical cork screw “worm” shape, other openers may also be used in place of cork screw 25 such as prongs, single or multiple spikes, tines, paired levers, hollow tubes, etc., as known to those of skill in the art. While housing 24 is described as a rounded concave and shown as generally spherical or globe shaped, other shapes are also within the scope of this disclosure including elliptical, oval, “tear” or “egg” shaped, a three-dimensional polygon shape, a three-dimensional hour glass shape, pyramid shaped, or shaped to resemble animals, objects, etc. Concave housing 24 and opener 22 may be made of plastic, metal, wood, polymers, synthetics, etc., as known to those of skill in the art. In addition, concave housing 24 may be formed from a single piece or multiple pieces. In a further embodiment, concave housing 24 may form a continuous surface. In a preferred embodiment, housing 24 is generally spherical and resembles one-half of a baseball covering. Opposing sides 29 and 31 form the generally spherical shape and are curved in appearance. Opposing sides 29 and 31 curve away from a rounded apex 27 located at the top of the device to form a rounded arch 33. Opposing sides 29 and 31 may form taper to points, rounded edges, or flattened edges, see FIG. 5 element 40, as they extend and curve way from apex 27.

Concave housing 24 defines at least one open face 26 via opposing sides 29 and 31. While sides 29 and 31 are described as opposing, and may be positioned substantially opposite one another in orientation, sides 29 and 31 may have different shapes from one another and may be positioned offset from one another such that they do not directly oppose one another but are offset at some angle between 90 and 270 degrees. Open face 26 may be a generally truncated tear shape but other shapes are also contemplated by this disclosure including circles, ovals, polygons, etc., as known to those of skill in the art. In a further embodiment, concave housing 24 defines two open faces 26 and 28 via defining the open faces in opposing sides 29 and 31. In a still further embodiment, open faces 26 and 28 together form substantially the same shape as the rounded concave housing. In a preferred embodiment, open faces 26 and 28 may also define a shape resembling one half of a baseball cover. Concave housing 24 defines a generally rounded interior 35 for storing opener 22. Although described as rounded, interior 35 may comprise other shapes such as angular or even be etched to add to the aesthetics of the device. In further embodiments, protrusions, such as ridges, etched gripping surfaces, etc., not shown, may be added to generally rounded interior 35 to aid the user in obtaining leverage while using the bottle opener or the wine opener.

Rounded interior 35 allows for easy storage and removal of opener 22 via access through open face 26 and/or 28. Prior art openers either leave the screw exposed from its handle or enclosure or they require at least a portion of the screw, or a shaft or member attached to the screw, to remain exterior to the enclosure for the opener to allow access for removing the opener from its enclosure. Alternatively, prior art devices form a tab or other protrusion on the opener that extends out from its enclosure for grasping and manipulating the opener into place. Such variations are unnecessary with the present disclosure. The present disclosure allows a user to simply push or pull opener 22 from within rounded interior 35. Indeed, opener 22 is completely contained within and surrounded by rounded interior 35 with no portion of opener 22 extending past opposing sides 29 and 31 when the opener is in the closed position 20. This allows for providing an aesthetically pleasing device that may sit on a counter-top or other surface without fear of a corkscrew or protrusion being exposed to snag those in the area, catch on clothes, scratch a counter-top, present a safety hazard, etc.

Concave housing 24 has at least one engaging surface 30. In a further embodiment, concave housing 24 has a second engaging surface 32. Opener 22 may be affixed to opener base 23, which in turn may be rotatably affixed to engaging surface 30 and 32, when used. This engagement may allow opener 22 and opener base 23 to have a full 360° field of rotation, with respect to engaging surface 30 and/or 32, around axle 34 within open faces 26 and 28. In other embodiments, opener 22 may have less than a 360° field of rotation such as 315°, 270°, 225°, 180°, 135°, 90°, 45°, etc., as well as variations between these measurements, including ranges of motion such as 45° to 90°, 90° to 180°, 180° to 270°, etc. In some embodiments, opener 22 may engage with engaging surface 30, and 32 when used, in a locking fashion such that opener 22 may be locked into place along various points of its field of rotation, for instance, the angles mentioned above or within a range of those angles, or at all points of its field of rotation. This enables a user to find a preferred angle or position to use the opener. This is especially helpful with those wanting to use leverage, rather than brute force, to remove the cork from a bottle. Locking may be accomplished via gearing, slots, magnetic engagement, male/female engagement, frictional engagement, etc., as known to those of skill in the art.

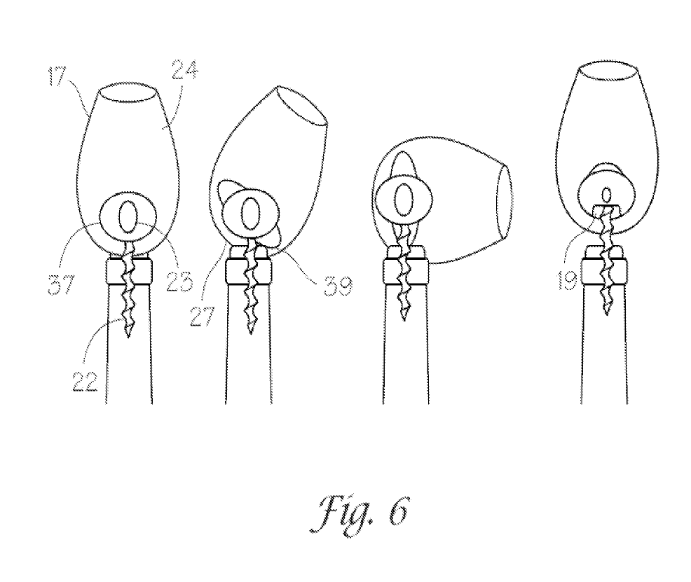

In a preferred embodiment, opener base 23 may be in the form of a cam 37. In a further embodiment, cam 37 may be polygon, circular, oval in shape, or shaped to resemble animals, objects, etc. In a further preferred embodiment, cam 37 may be in the form of an oval. In use, cam 37 remains stationary with respect to the rim of a wine, or other bottle, as concave housing 24 is rotated about cam 37. FIG. 6 illustrates one possible embodiment of concave housing 24 as it is used to remove a cork from a bottle by rotating. In a still further preferred embodiment, concave housing 24 is rotated to approximately 90° with respect to cam 37 from concave housing 24 upright position 17. However, other variations of rotation are possible, and within the scope of this disclosure, with concave housing 24 rotating over a range of approximately 180° with respect to cam 37, such as 200°, 190°, 180°, 170°, 160°, 150°, 140°, 135°, 130°, 120°, 110°, 100°, 80°, 70°, 60°, 50°, 45°, 40°, 30°, 20°, 10°, 0° etc., and within ranges of the above fixed points, with respect to opener base 23. As concave housing 24 rotates from upright position 17 with respect to opener base 23, opener rails 39 and 41, formed on concave housing 24 positioned on either side of cam 37, engage the upper surface of the bottle being opened. Opener rails 39 and 41 may be polygon, circular, or oval in shape, or shaped to resemble animals, objects, etc. In a preferred embodiment, opener rails 39 and 41 are the same shape as opener base 23. In a still further embodiment, opener rails 39 and 41 are oval shaped. As concave housing 24 rotates with respect to opener base 23, which is engaged with the cork of the bottle via cork screw 25, or another type of opener as described herein, opener rails 39 and 41 press against the upper surface of the bottle and begin to lever out the cork from the bottle opening. Then, the user may rotate concave housing 24 to an upright, or other position, with respect to opener base 23 and finish removing the cork from the bottle. This embodiment allows the user to exert leverage against the cork by simply moving concave housing 24 with respect to its engaged opener base 23. This causes opener rails 39 and 41 to engage the bottle opening rim and begin levering the cork from the bottle. In a further embodiment, a recess 19 may be formed in opener base 23 to engage a topmost portion of the cork being removed.

Opener 10 may also have at least one bottle opener 36 formed by cooperation between an edge 40 of concave housing 24 and a leverage surface 42 positioned on a distal surface 44 of opener base 23 opposite opener 22 on proximal surface 46 of opener base 23. In a further embodiment, a second bottle opener 38 may be formed by cooperation between a second edge 48 of concave housing 24 and leverage surface 42. Edge 40 and second edge 48 may end in tapered or blunt points to aid in grasping and opening a bottle cap. Indentions, not shown, may also be worked into edge 40 and edge 48 to allow the bottle cap to “nestle” into the concave housing 24 to provide additional leverage for opening a bottle using leverage surface 42. While leverage surface 42 is depicted as a raised mound, surface 42 may be angular, sloped, ramp shaped, a pole, a tab, a ridge, a curved ridge, a double curved ridge with openings facing outward, or otherwise formed as known to those of skill in the art to aid with engaging and holding a bottle cap, not shown, to aid in removal of same.

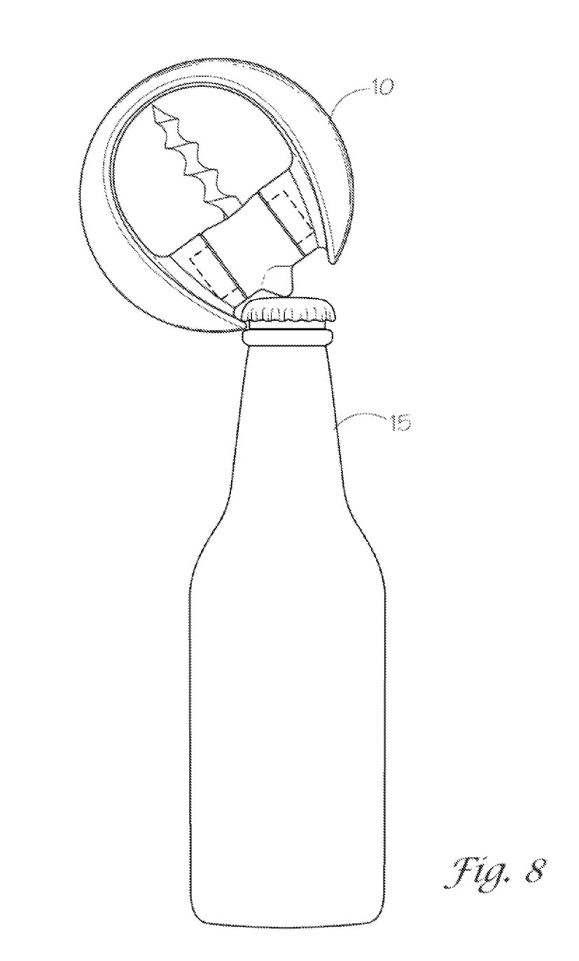

Engagement of opener 10 and bottle 15 is shown via FIG. 8 with opener 10 in closed position 20. However, engagement between leverage surface 42 and edges 40 and 48 may occur along various positions, determined by the angle of opener 22. This allows for shaping edges 40 and 48 to serve various sized bottles, indeed edges 40 and 48 may have different shapes to accommodate different types of bottles, or by shaping or allowing leverage surface 42 to act as a “pick” for cans via shifting the position of opener 22 with respect to edges 40 and 48. In a preferred embodiment, leverage surface 42 is positioned below the plane defined by edges 40 and 48 such that leverage surface 42 does not meet and/or extend above the plane formed by the edges.

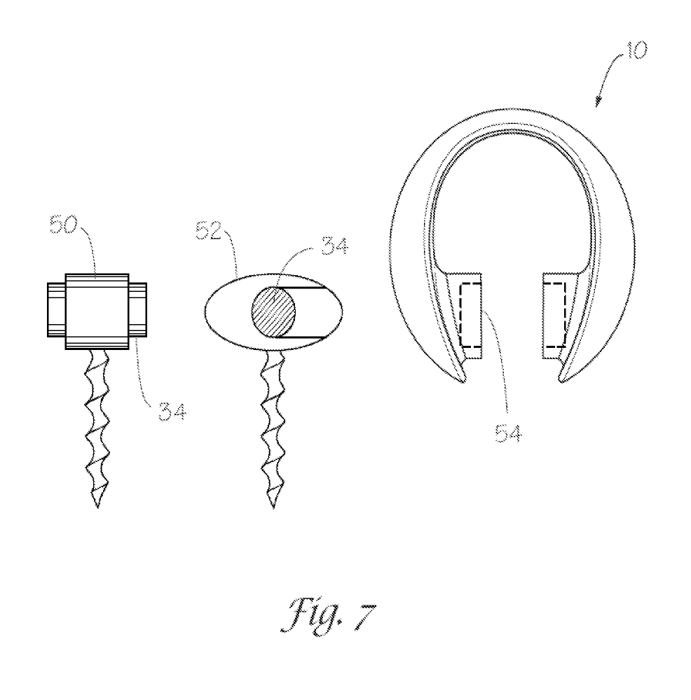

FIG. 7 shows a disassembled view of opener 10 wherein opener base 23 has been removed from concave housing 24. FIG. 7 shows a front view 50 and side view 52 of opener base 23. Axle 34 is also shown, which may run completely through opener base 23 or may be formed from two parts, one on each side of opener base 23. Also shown is axle housing 54 which engages and holds axle 34.

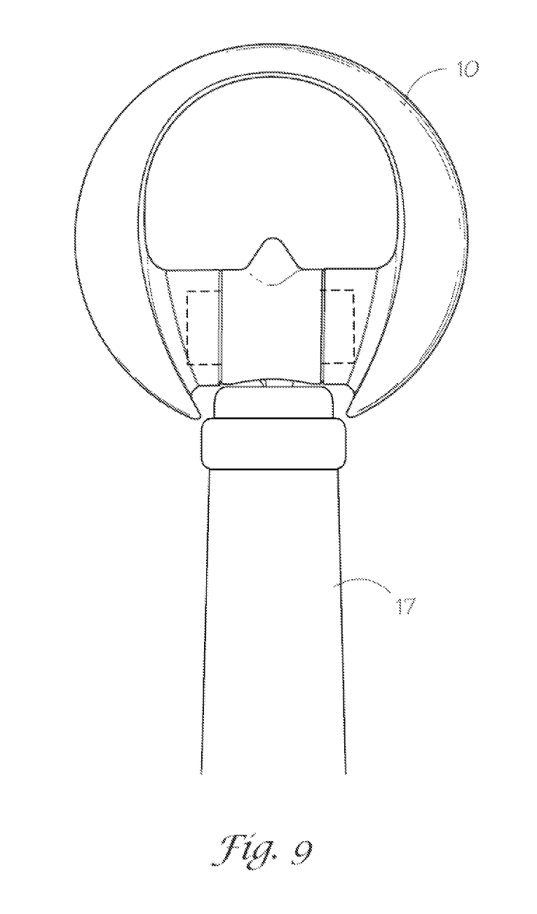

FIGS. 8 and 9 show an opener 10 described by the present disclosure engaged with a beer bottle 15 and a wine bottle 17, respectively.

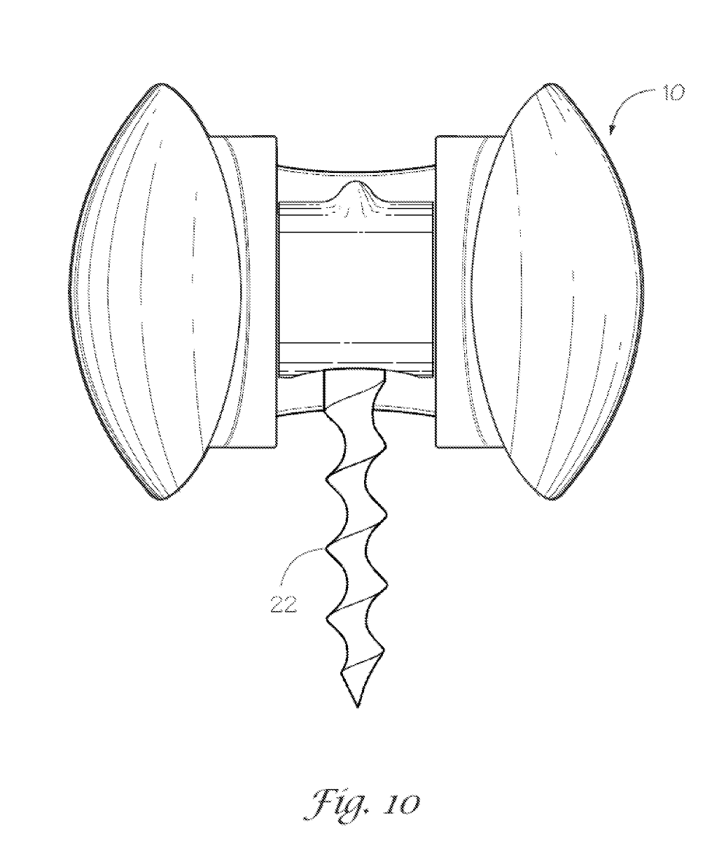

FIG. 10 shows opener 10 with opener 22 rotated to approximately 90°.

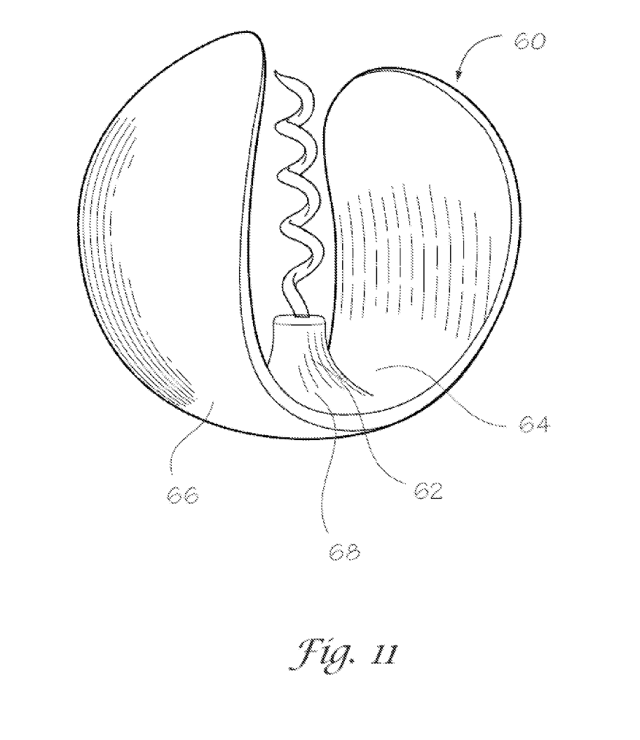

FIG. 11 shows an alternative embodiment wherein opener 60 has a fixed opener 62. This embodiment allows for maintaining fixed opener 62 within the confines of open housing 66 but does away with movable opener base 23 of the prior embodiment. Opener 62 may be affixed to an interior surface 64 of open housing 66 along various points of the interior. In a preferred embodiment, fixed opener 62 is attached at generally the interior apex 68 of open housing 66. Attachment may be accomplished via welding, adhesives, mold forming opener 60 as a one-piece unit, etc., as known to those of skill in the art. As described above, opener 60 and fixed opener 62 while shown as generally spherical and a cork screw may be presented as other shapes as described herein, which form part of this disclosure.

While a preferred embodiment of the invention has been described using specific terms, such description is for illustrative purposes only, and it is to be understood that changes and variations may be made without departing from the spirit or scope of the following claims.

What is claimed is:

1. A combination corkscrew bottle opener comprising:
a rounded concave housing defining at least one open face having at least one engaging surface;
an opener base orbitally attached to the at least one engaging surface;
an opener attached to the opener base, wherein the opener is capable of rotating at least 180 degrees with respect to the engaging surface; and
at least one bottle opener formed by one surface of the opener base and a portion of the concave housing.

2. The combination corkscrew bottle opener of claim 1, wherein the rounded concave housing is shaped to resemble one-half of a baseball cover.

3. The combination corkscrew bottle opener of claim 1, wherein the rounded concave housing has opposing sides forming the rounded concave housing.

4. The combination corkscrew bottle opener of claim 1, wherein there is a first open face and a second open face and the shape of the first open face and the second open face together define substantially the same shape as the rounded concave housing.

5. The combination corkscrew bottle opener of claim 4, wherein the first open face and the second open face define a shape resembling one-half of a baseball cover.

6. The combination corkscrew bottle opener of claim 1, wherein the opener has at least an open and a closed position, wherein in the closed position, the opener is located within and surrounded by the rounded concave housing.

7. The combination corkscrew bottle opener of claim 1, wherein the opener is locked into place along various points of its rotation.

8. The combination corkscrew bottle opener of claim 1, wherein the at least one bottle opener is formed by an edge of the rounded concave housing and a leverage point located on the opener base.

9. The combination corkscrew bottle opener of claim 8, wherein the leverage point comprises a raised protrusion on the opener base.

10. The combination corkscrew bottle opener of claim 1, wherein the opener base is in the form of a cam and the orientation of the cam remains substantially stationary with respect to a rim of a wine bottle being opened.

11. A shaped corkscrew comprising:
a continuous surface forming a rounded concave housing defining at least one open face;
the continuous surface having at least one engaging surface;
an opener base rotationally attached to the at least one engaging surface;
an opener attached to the opener base, the opener and opener base capable of radial rotation with respect to the engaging surface; and
a leverage point formed on one surface of the opener base.

12. The shaped corkscrew of claim 11, wherein the continuous surface is shaped to resemble one-half of a baseball cover.

13. The shaped corkscrew of claim 11, wherein the continuous surface has opposing sides forming the rounded concave housing.

14. The shaped corkscrew of claim 11, wherein there the continuous surface defines a first open face and a second open face and the shape of the first open face and the second open face together define substantially the same shape as the rounded concave housing.

15. The shaped corkscrew of claim 14, wherein the first open face and the second open face define a shape resembling one-half of a baseball cover.

16. The shaped corkscrew of claim 11, wherein the opener has at least an open and a closed position, wherein in the closed position, the opener is located within and surrounded by the continuous surface.

17. The shaped corkscrew of claim 11, wherein the opener locks into place along various points of its rotation.

18. The shaped corkscrew of claim 11, wherein the leverage point cooperates with a portion of the concave housing to form at least one bottle opener.

19. The shaped corkscrew of claim 18, wherein the at least one bottle opener is formed by the leverage point comprising a raised protrusion located on the opener base.

20. The shaped corkscrew of claim 11, wherein the opener base is in the form of a cam and the orientation of the cam remains substantially stationary with respect to a rim of a wine bottle being opened.
